(19) United States
(12) Patent Application Publication
(10) Pub. No.: US 2026/0066572 A1
(43) Pub. Date: Mar. 5, 2026

(54) STACK CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shinji NOZAKI, Mie (JP)

(21) Appl. No.: 19/107,025

(22) PCT Filed: Aug. 29, 2023
(86) PCT No.: PCT/JP2023/031109

§ 371 Date: Feb. 27, 2025

(30) Foreign Application Priority Data
Sep. 2, 2022 (JP) 2022-139883

(51) Int. Cl. H01R 13/514

(52) U.S. Cl. CPC H01R 13/514

(57) ABSTRACT

It is aimed to protect tabs. A stack connector (A) includes a plurality of housings (21, 22, 23, 24) to be assembled in a stacked state, male terminal fittings (40) each including an elongated tab (42) and to be mounted into the housings (21, 22, 23, 24) with the tabs projecting forward from the housings (21, 22, 23, 24), and covers (50) including covering portions (51) for covering the tabs (42). With the covers (50) attached to the housings (21, 22, 23, 24), the tabs (42) can be protected by the covering portions (51).

### TECHNICAL FIELD

The present disclosure relates to a stack connector.

### BACKGROUND

Patent Document 1 discloses a male connector including a plurality of stacked flat male sub-housings and male terminal fittings mounted in the respective male sub-housings. This male connector is mounted in a male holder including a receptacle, and a moving plate is accommodated in the receptacle. Tabs on the tips of the male terminal fittings are positioned by the moving plate.

### PRIOR ART DOCUMENT

### Patent Document

Patent Document 1: JP 2011-044386 A

### SUMMARY OF THE INVENTION

### Problems to be Solved

In a state where the male connector is not mounted in the male holder, the tabs of the male terminal fittings are exposed by projecting forward from the male sub-housings. Thus, the tabs may be deformed due to interference with another member.

A stack connector of the present disclosure was completed on the basis of the above situation and aims to protect tabs.

### Means to Solve the Problem

The present disclosure is directed to a stack connector with a plurality of housings to be assembled in a stacked state, male terminal fittings each including an elongated tab in a front end part, the male terminal fittings being mounted into the housings with the tabs projecting forward from the housings, and covers to be attached to the housings, the covers including covering portions for covering the tabs.

### Effect of the Invention

According to the present disclosure, tabs can be protected.

### BRIEF DESCRIPTION OF THE DRAWINGS

FIG. 1 is a perspective view of a stack connector of one embodiment when viewed obliquely from an upper front side.

FIG. 2 is a back view in section of the stack connector.

FIG. 3 is a perspective view showing a disassembled state of the stack connector when viewed obliquely from an upper rear side.

FIG. 4 is a perspective view showing a state where the stack connector is set in a jig when viewed obliquely from the upper front side.

FIG. 5 is a perspective view showing a state where covers are removed from housings using the jig when viewed obliquely from the upper front side.

FIG. 6 is a perspective view of a third housing when viewed obliquely from the upper rear side.

FIG. 7 is a perspective view of the third housing when viewed obliquely from a lower rear side.

FIG. 8 is a perspective view of the cover when viewed obliquely from the upper rear side.

FIG. 9 is a perspective view of the cover when viewed obliquely from the lower rear side.

FIG. 10 is a side view showing a stacking process of the connector.

FIG. 11 is a side view in section showing the stacking process of the connector.

FIG. 12 is a plan view in section showing a state where a holding function by receiving portions and resilient holding pieces is exhibited.

FIG. 13 is a plan view in section showing a state where the holding function by the receiving portions and the resilient holding pieces is released.

### DETAILED DESCRIPTION TO EXECUTE THE INVENTION

### Description of Embodiments of Present Disclosure

First, embodiments of the present disclosure are listed and described.
(1) The stack connector of the present disclosure is provided with a plurality of housings to be assembled in a stacked state, male terminal fittings each including an elongated tab in a front end part, the male terminal fittings being mounted into the housings with the tabs projecting forward from the housings, and covers to be attached to the housings, the covers including covering portions for covering the tabs. According to the configuration of the present disclosure, the tabs can be protected by the covering portions with the covers attached to the housings.
(2) Preferably, the housings and the covers are formed with holding portions for holding the housings and the covers in an attached state, and one of two housings overlapped in a stacked state is formed with a hold releasing portion for releasing a holding function of the holding portion in the other housing as the one housing is stacked on the other housing. According to this configuration, since the holding function of the holding portions is released only by stacking the housings, a separate step (separate operation) for releasing the holding function of the holding portions is unnecessary.
(3) Preferably, in (2), out of the two covers overlapped in the stacked state, one cover attached to the one housing is formed with a separation restricting portion for restricting separation of the other cover from the other housing. If the other cover is removed from the other housing immediately when the hold by the holding portions are released, the tabs are kept exposed in the process of stacking the housings thereafter. In view of this point, the other cover released from the hold by the holding portions is kept in a state not separated from the other housing by the separation restricting portion. In this way, the tabs can be prevented from being exposed in the process of stacking the housings. If the hold of one housing stacked last and one cover is released after all the housings are stacked, all the covers can be removed from the housings.
(4) Preferably, in (3), the holding portions formed in the one housing and the one cover are arranged to be exposed on outer surfaces of the one housing and the one cover. According to this configuration, the hold of the one housing overlapped last and the one cover is easily released with all the housings stacked.
(5) Preferably, in (3) or (4), the covers are formed with jig locking portions arranged in a stacking direction with the housings stacked. According to this configuration, all the covers can be removed from the housings by one action by locking a jig or the like to all the jig locking portions with all the housing and all the covers stacked.
(6) Preferably, in (1) to (4), an inspection opening is formed in a front surface of the cover, a probe for continuity inspection being inserted through the inspection opening to contact the tab. According to this configuration, continuity inspection can be carried with the tabs surrounded by the cover.

### Details of Embodiment of Present Disclosure

### Embodiment

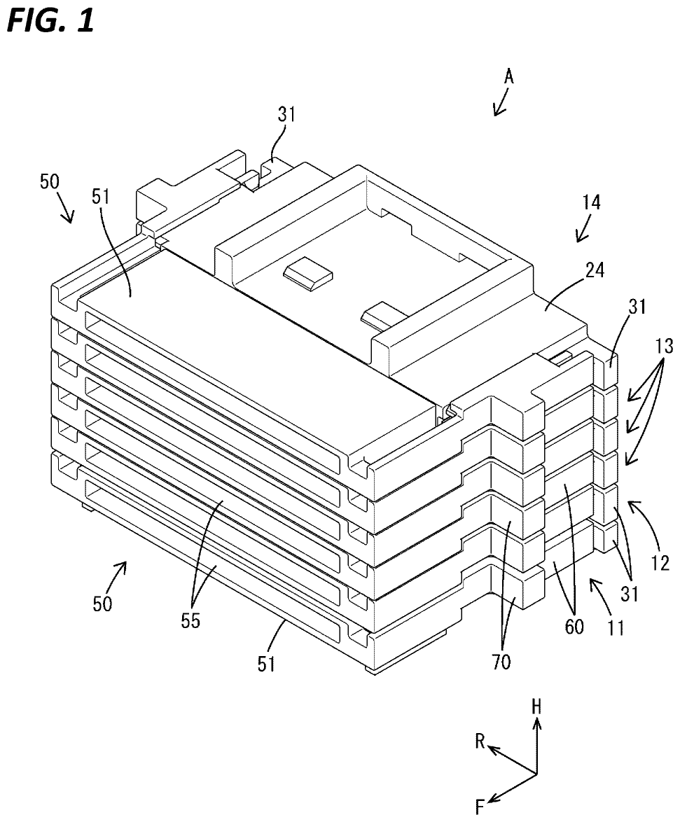

A stack connector A of one specific embodiment of the present disclosure is described with reference to FIGS. 1 to 13. The present invention is not limited to these illustrations, but is represented by claims and intended to include all changes in the scope of claims and in the meaning and scope of equivalents. In this embodiment, a direction F in FIGS. 1 and 3 to 13 is defined as a forward direction concerning a front-rear direction. A direction R in FIGS. 1 to 9, 12 and 13 is defined as a rightward direction concerning a lateral direction. The lateral direction and a width direction are used as synonyms. A direction H in FIGS. 1 to 11 is defined as an upward direction concerning a vertical direction. The vertical direction and a height direction are used as synonyms.

### Summary of Stack Connector A

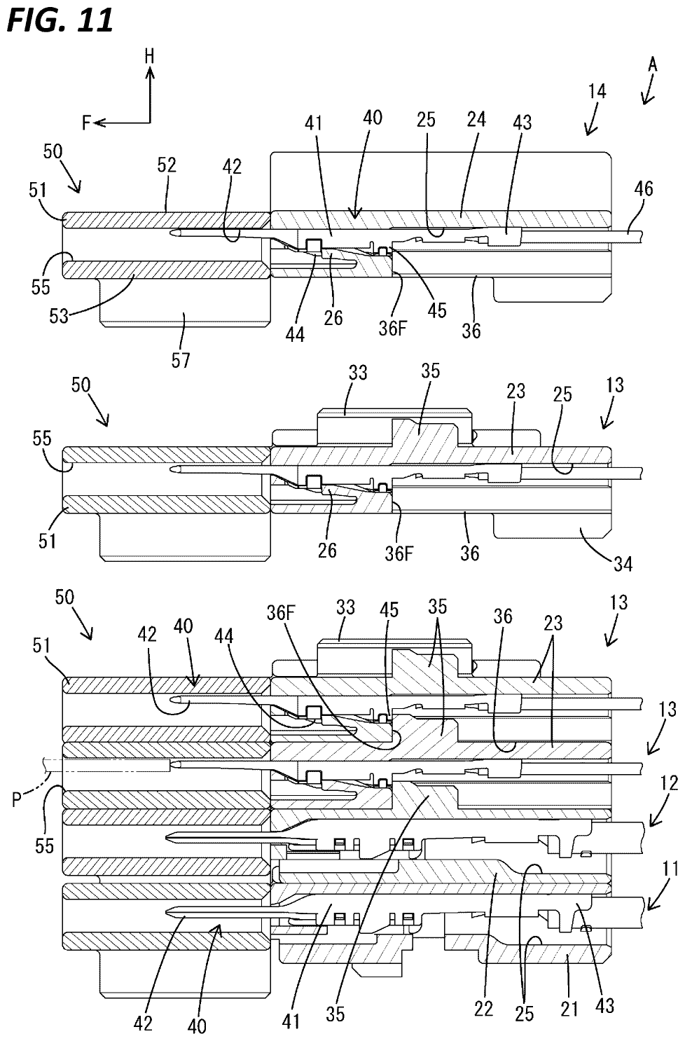

As shown in FIGS. 1 to 3, the stack connector A of this embodiment is provided with a plurality of types (in this embodiment, four first to fourth types) of sub-connectors 11, 12, 13 and 14. As shown in FIG. 11, each sub-connector 11, 12, 13, 14 is provided with a housing 21, 22, 23, 24, a plurality of male terminal fittings 40 mounted in the housing 21, 22, 23, 24 and a cover 50 attached to the housing 21, 22, 23, 24.

The sub-connector 11, 12, 13, 14 has a flat rectangular parallelepiped shape having a height smaller than a depth in the front-rear direction and a width in the lateral direction as a whole. By assembling the plurality of types of sub-connectors 11, 12, 13 and 14 in a state stacked in the height direction, the stack connector A is configured. Specifically, one first sub-connector 11, one second sub-connector 12, three third sub-connectors 13 and one fourth sub-connector 14 are stacked in this order from bottom.

The assembled stack connector A is mounted into an unillustrated outer housing with the cover 50 removed from each housing 21, 22, 23, 24, i.e. with tabs 42 of the male terminal fittings 40 projecting forward from the front surface of each housing 21, 22, 23, 24. The outer housing includes a frame for accommodating the housings 21, 22, 23 and 24 in the stacked state and a receptacle in the form of a rectangular tube projecting forward from the frame. A plurality of the tabs 42 projecting from the housings 21, 22, 23 and 24 are collectively surrounded by the receptacle. Front end parts of the plurality of tabs 42 are positioned by a moving plate (not shown) accommodated into the receptacle.

### Configurations of Housings 21, 22, 23 and 24

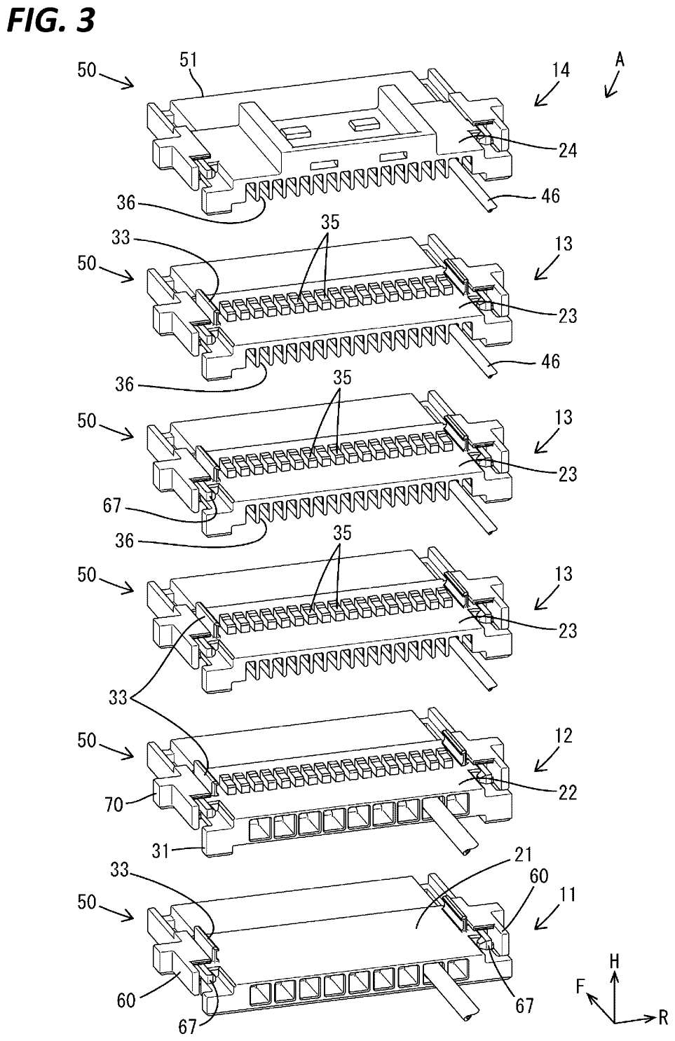

A common structure of the first to fourth housings 21, 22, 23 and 24 is described with reference to FIGS. 3, 6, 7 and 11. Each housing 21, 22, 23, 24 has a flat rectangular parallelepiped shape having a height smaller than a depth in the front-rear direction and a width in the lateral direction as a whole. As shown in FIG. 11, a plurality of terminal accommodation chambers 25 elongated in the front-rear direction are formed in parallel in the width direction in each housing 21, 22, 23, 24. The terminal accommodation chambers 25 are open in both front and rear end surfaces of the housing 21, 22, 23, 24. A locking lance 26 for retaining the male terminal fitting 40 to be described later is formed in each terminal accommodation chamber 25.

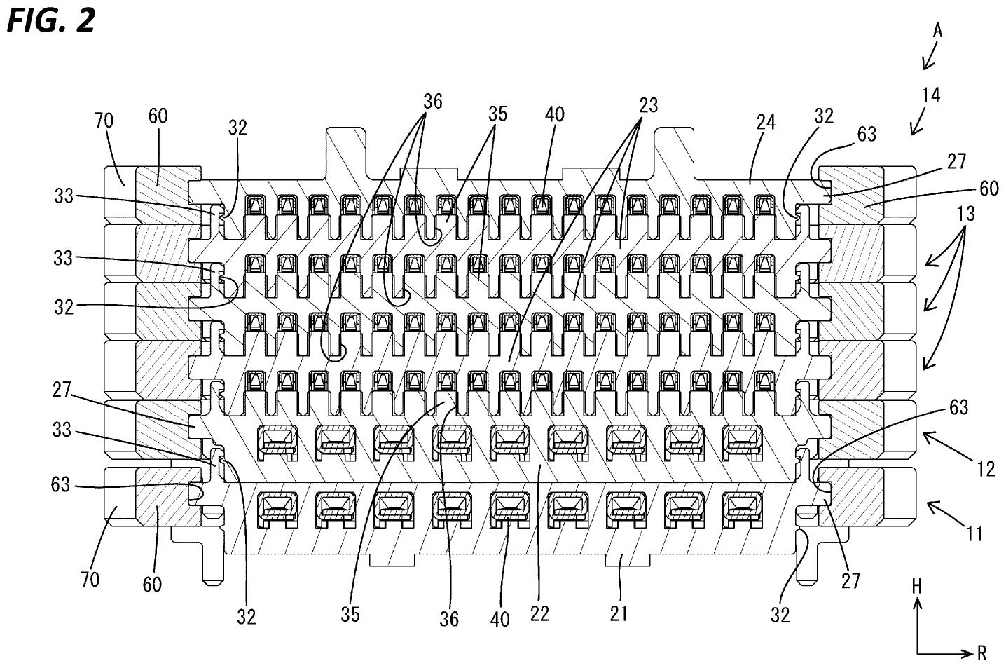

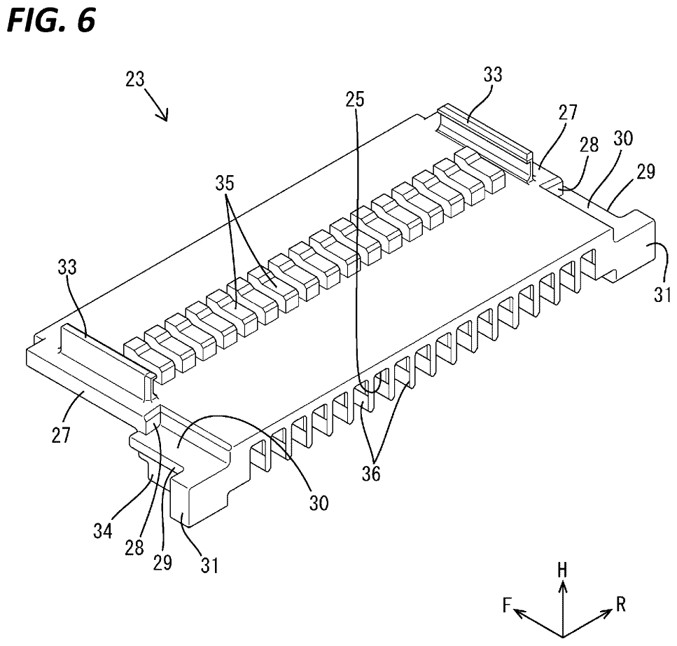

As shown in FIGS. 2 and 6, a pair of guide ribs 27 are formed on both left and right outer side surfaces of the housing 21, 22, 23, 24. The guide ribs 27 are parts functioning as guide portions for guiding the cover 50 when the cover 50 is attached to or removed from the housing 21, 22, 23, 24. The guide rib 27 is shaped to project outward in the width direction from the outer side surface of the housing 21, 22, 23, 24 and extend straight in the front-rear direction. The guide rib 27 is arranged in a front end side region of the housing 21, 22, 23, 24. A rear end part of the guide rib 27 functions as a receiving portion 28. The receiving portion 28 has a function of holding the cover 50 in a state assembled with the housing 21, 22, 23, 24 and a function of restricting relative displacements of two housings 21, 22, 23, 24 overlapped in a stacked state in the front-rear direction.

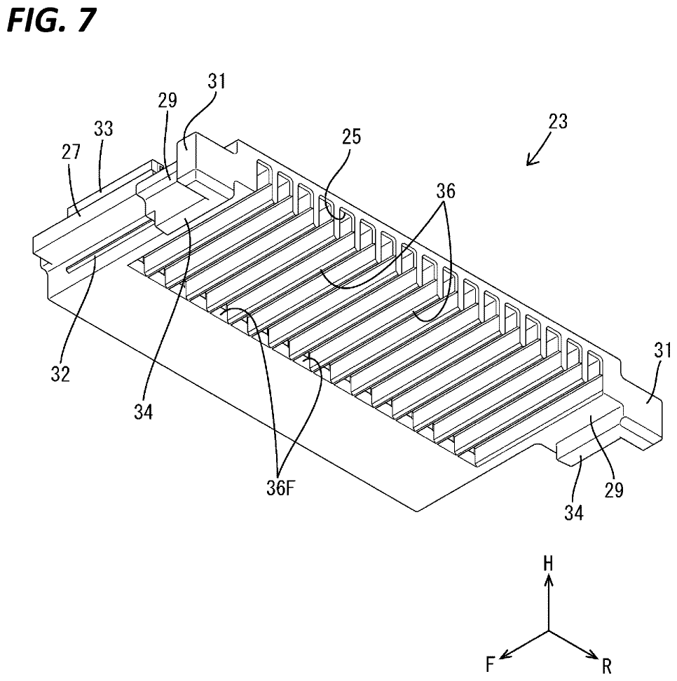

As shown in FIGS. 6 and 7, bulging portions 29 projecting outward in the width direction are formed in rear end side regions of the both left and right outer side surfaces. The upper surfaces of the bulging portion 29 are located below the upper surface of the housing 21, 22, 23, 24 and the receiving portions 28, and upper surface recesses 30 are formed above the bulging portions 29 due to this height difference. In a plan view of the housing 21, 22, 23, 24 from above, the receiving portions 28 and the upper surface recesses 30 are arranged adjacent to each other in the front-rear direction. A jig fixing portion 31 shaped to project outward in the width direction is formed in a rear end part of the bulging portion 29. As shown in FIGS. 2 and 7, lock projections 32 in the form of ribs extending in the front-rear direction are formed on the both left and right outer side surfaces of the housing 21, 22, 23, 24. The above is the common structure of the first to fourth housings 21, 22, 23 and 24.

As shown in FIGS. 2, 3 and 6, resilient lock pieces 33 in the shape of walls projecting upward are formed in both left and right end parts of the upper surface of each of the first to third housings 21, 22 and 23. The resilient lock piece 33 can be resiliently deformed to be inclined in the lateral direction. As shown in FIG. 2, the resilient lock pieces 33 are locked to the lock projections 32, whereby the housings 21, 22, 23 and 24 overlapping in the vertical direction are locked in the stacked state.

Each of the second to fourth housings 22, 23 and 24 is formed with hold releasing portions 34 (see FIGS. 6, 7 and 10). The hold releasing portion 34 is a part of the bulging portion 29 projecting further downward than the lower surface of the housing 22, 23, 24. In a plan view, the hold releasing portion 34 is arranged in the same region as the upper surface recess 30. The hold releasing portion 34 has a function of releasing the locking of each of the first to third housings 21, 22 and 23 and the cover 50.

As shown in FIGS. 2, 3, 6 and 11, each of the second and third housings 22, 23 is formed with a plurality of projections 35. The plurality of projections 35 are arranged side by side at predetermined intervals in the width direction on the upper surface of each of the second and third housings 22, 23. In the width direction, the plurality of projections 35 are arranged at the same positions as the terminal accommodation chambers 25 formed in each of the third and fourth housings 23, 24. In the front-rear direction, the projections 35 are arranged behind the locking lances 26.

As shown in FIGS. 2, 3, 7 and 11, each of the third and fourth housings 23, 24 is formed with a plurality of cut portions 36. Each cut portion 36 has a shape elongated in the front-rear direction along the terminal accommodation chamber 25 by cutting a bottom wall portion of each of the third and fourth housings 23, 24. As shown in FIG. 11, a front end edge 36F of the cut portion 36 is located behind the locking lance 26. The cut portion 36 communicates with the terminal accommodation chamber 25 over an entire length. A rear end part of the cut portion 36 communicates with an opening of the terminal accommodation chamber 25 in the rear end surface of each of the third and fourth housings 23, 24.

### Configuration of Male Terminal Fitting 40

The male terminal fitting 40 has a shape elongated in the front-rear direction as a whole. As shown in FIG. 11, the male terminal fitting 40 includes a terminal body portion 41, the elongated tab 42 cantilevered forward from the terminal body portion 41 and a crimping portion 43 extending rearward from the terminal body portion 41. The crimping portion 43 is connected to a front end part of a wire 41 by crimping. A projection-like primary locking portion 44 is formed in a central region in the front-rear direction of the terminal body portion 41. A step-like secondary locking portion 45 is formed in a rear end part of the terminal body portion 41.

### Configuration of Cover 50

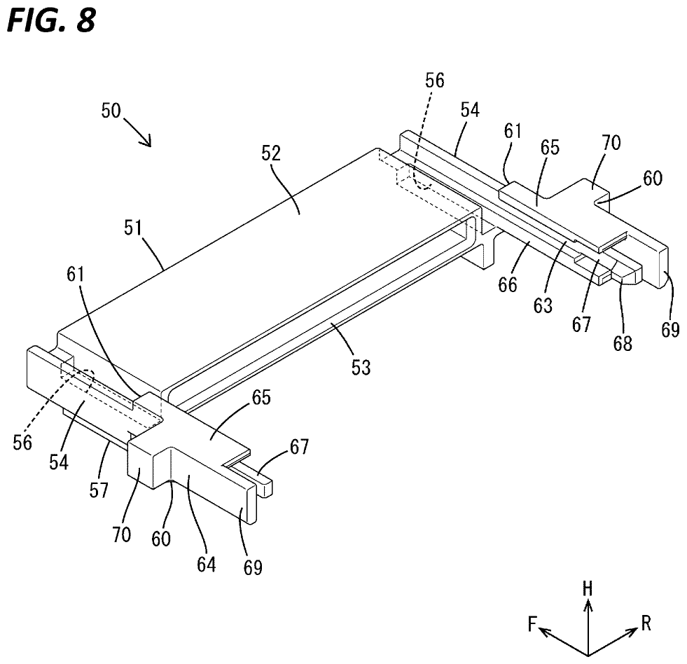

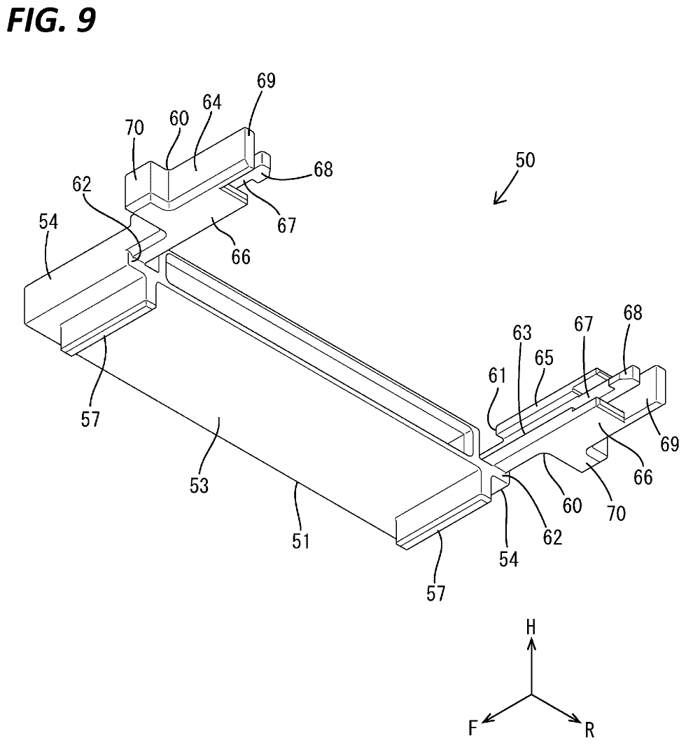

The cover 50 is a component common to the first to fourth housings 21, 22, 23 and 24. The cover 50 is a single component made of synthetic resin. As shown in FIGS. 8 and 9, the cover 50 has a flat shape having a height smaller than a depth in the front-rear direction and a width in the lateral direction. The cover 50 includes one covering portion 51 in the form of a flat rectangular tube and a pair of bilaterally symmetrical arm portions 60.

The covering portion 51 includes an upper wall portion 52, a lower wall portion 53 and a pair of left and right side wall portions 54. As shown in FIG. 11, an inspection opening 55 elongated in the lateral direction is formed in the front surface of the covering portion 51. The inspection opening 55 is an opening allowing an internal space of the covering portion 51 to communicate with a space in front of and outside the covering portion 51. The both left and right side wall portions 54 have a width substantially equal to a height thereof and are in the form of thick blocks as a whole. The both side wall portions 54 are formed with positioning recesses 56 elongated in the front-rear direction by recessing the upper surface of the side wall portions 54. The both side wall portions 54 are formed with positioning protrusions 57 projecting downward from the lower surfaces thereof. In a plan view of the cover 50 from above, the positioning protrusions 57 are arranged in the same regions as the positioning recesses 56.

The pair of arm portions 60 are shaped to be cantilevered rearward from both left and right end parts of the covering portion 51, i.e. the rear ends of the side wall portions 54. The upper surface of the arm portion 60 is set to be higher than the upper surface of the side wall portion 54, and a step-like abutting portion 61 facing forward is formed in a front end part of the arm portion 60 due to this height difference. The lower surface of the arm portion 60 is set to be higher than the lower surface of the side wall portion 54, and a step-like separation restricting portion 62 facing rearward is formed in a rear end part of the side wall portion 54 due to this height difference.

Each arm portion 60 is formed with a guide groove 63 shaped to extend straight in the front-rear direction. The guide groove 63 is configured by a side plate portion 64, an upper plate portion 65 and a lower plate portion 66 and is open in an inner side surface (surface facing the opposite arm portion 60) of the arm portion 60. The front end of the guide groove 63 is open in the front end surface of the arm portion 60, and the rear end thereof is open in the rear end surface of the arm portion 60. The guide groove 63 is a guide portion which exhibits a function of stabilizing the posture of the cover 50 with respect to the housing 21, 22, 23, 24 and a function of guiding the cover 5 along a predetermined path. A dimension in the front-rear direction from the rear end surface of the covering portion 51 to the rear end of the guide groove 63 is set to be larger than a dimension from the front end surface of the housing 21, 22, 23, 24 to the front ends of the tabs 42 (projecting dimension of the tabs 42).

The pair of arm portions 60 are formed with a pair of resilient holding pieces 67. The resilient holding piece 67 is arranged in a rear end part of the guide groove 63 and in the shape of a cantilever extending rearward. A holding projection 68 projecting inward in the width direction (direction toward the resilient holding piece 67 on an opposite side) is formed in a rear end part of the resilient holding piece 67. The resilient holding piece 67 can be resiliently deformed in the width direction with a front end part of the resilient holding piece 67 as a fulcrum. Out of the resilient holding piece 67, a part in front of the holding projection 68 constitutes a rear end part of the side plate portion 64. Out of the resilient holding piece 67, a rear end part formed with the holding projection 68 is arranged behind the rear end of the upper plate portion 65.

A protecting portion 69 for protecting the resilient holding piece 67 is formed in a rear end part of the arm portion 60. The protecting portion 69 is a wall-like part arranged outwardly of the resilient holding piece 67 in the width direction. A front end part of the protecting portion 69 is connected to the outer side surface of the side plate portion 64. A front end side region of the protecting portion 69 is connected to the upper plate portion 65 and the lower plate portion 66. The arm portion 60 is formed with a jig locking portion 70. The jig locking portion 70 is in the shape of a block projecting outward in the width direction from the outer side surface of the front end part of the protecting portion 69. The jig locking portion 70 is arranged in a region range in the front-rear direction of the arm portion 60 where the guide groove 63 is formed. The strength and rigidity of a part of the arm 60 formed with the guide groove 63 are enhanced by the jig locking portion 70 having a large width.

### Procedure of Attaching Covers 50 to Housings 21, 22, 23 and 24

The covers 50 are attached to the first to fourth housings 21, 22, 23 and 24 before the male terminal fittings 40 are mounted into the housings 21, 22, 23 and 24. In attaching, the cover 50 is brought closer to housing 21, 22, 23, 24 from front and the rear end parts of the guide grooves 63 are fit to front end parts of the guide ribs 27 by sliding the rear end parts of the arm portions 60 along the outer side surfaces of the housing 21, 22, 23, 24. By fitting the guide ribs 27 and the guide grooves 63, the cover 50 is positioned in the vertical direction and the lateral direction with respect to the housing 21, 22, 23, 24. At this time, since the holding projections 68 interfere with the guide ribs 27, the resilient holding pieces 67 are resiliently deformed outward in the width direction.

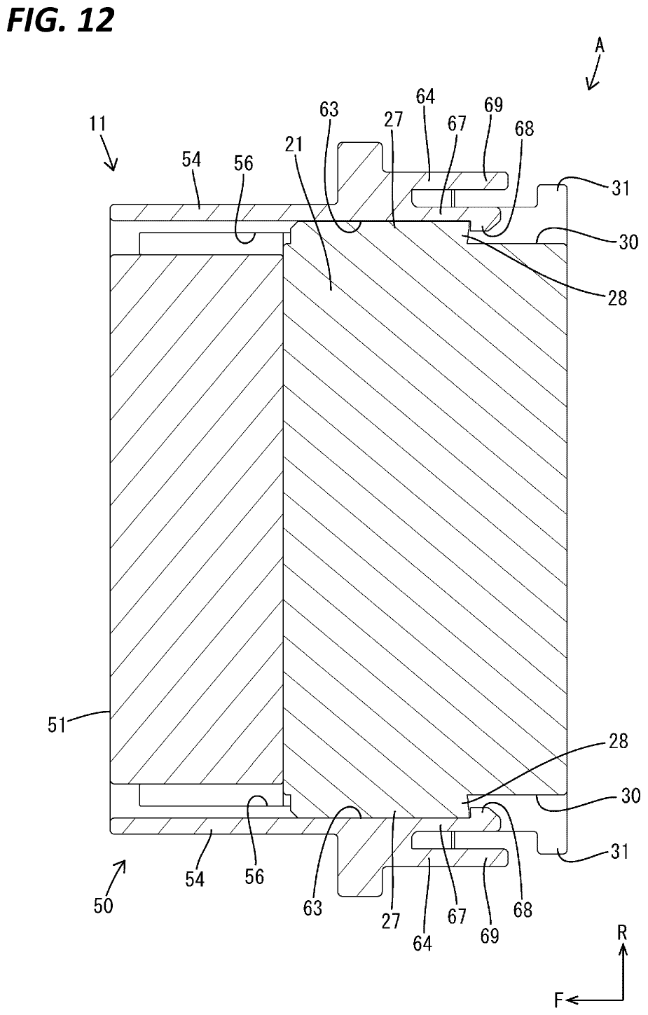

If the cover 50 is moved rearward from this state, the cover 50 is held in a fixed posture by the sliding contact of the guide ribs 27 and the guide grooves 63 and the assembly of the cover 50 with the housing 21, 22, 23, 24 proceeds. If the cover 50 reaches a proper assembly position, the holding projections 68 pass through the rear ends of the guide ribs 27, wherefore the resilient holding pieces 67 resiliently return inward in the width direction and the holding projections 68 are locked to the receiving portions 28 from behind as shown in FIG. 12. By this locking, the cover 50 is restricted from being separated forward from the housing 21, 22, 23, 24. In a state where the proper assembly position is reached, the rear end surface of the covering portion 51 is in surface contact with the front end surface of the housing 21, 22, 23, 24. By this contact, the cover 50 is restricted from being relatively displaced rearward with respect to the housing 21, 22, 23, 24. In the above way, the cover 50 is held in a state assembled with the housing 21, 22, 23, 24.

After the cover 50 is assembled with the housing 21, 22, 23, 24, the male terminal fittings 40 are mounted into each housing 21, 22, 23, 24. As shown in FIG. 11, the male terminal fitting 40 is mounted into the housing 21, 22, 23, 24 with the terminal body portion 41 and the crimping portion 43 accommodated in the terminal accommodation chamber 25 and with the tab 42 projecting forward from the front end surface of the housing 21, 22, 23, 24. The male terminal fitting 40 mounted in the housing 21, 22, 23, 24 is held with a rearward movement restricted by locking the primary locking portion 44 formed on the terminal body portion 41 by the locking lance 26. In each housing 21, 22, 23, 24, the plurality of tabs 42 projecting forward from the housing 21, 22, 23, 24 are collectively covered and surrounded over an entire periphery in the vertical direction and the lateral direction by one covering portion 51. Therefore, there is no possibility that an external matter interferes with the tabs 42. In the above way, the assembly of the first to fourth sub-connectors 11, 12, 13 and 14 is completed.

### Assembly Procedure of Stack Connector A

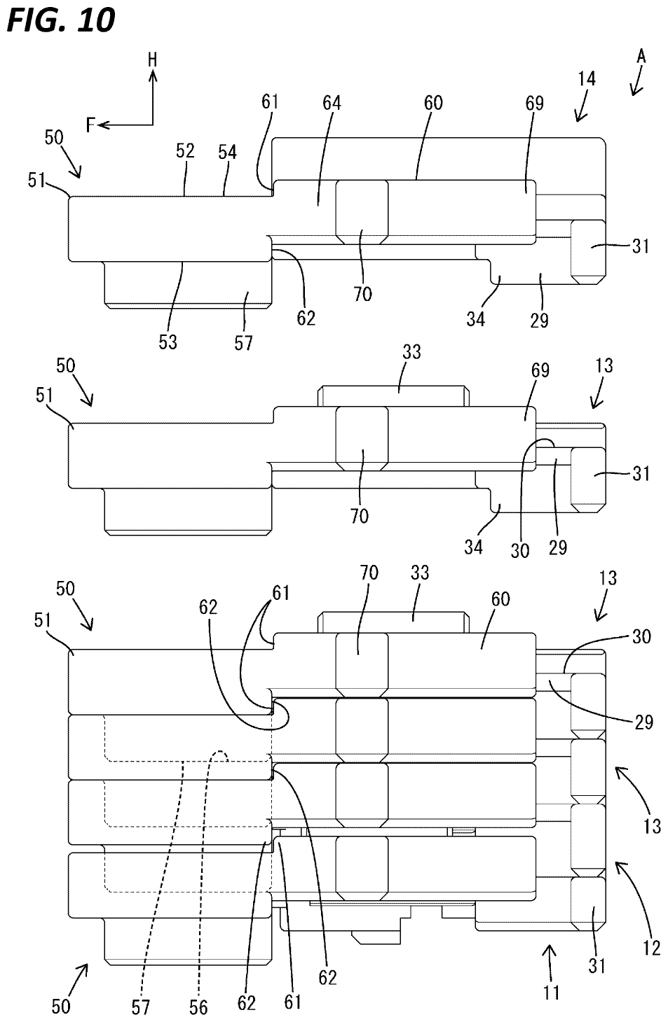

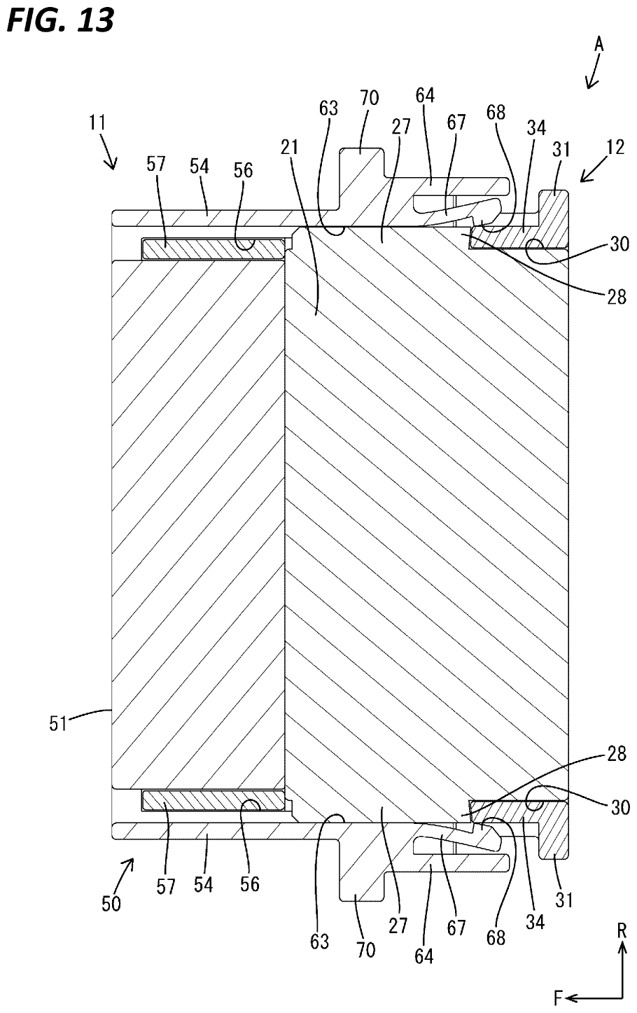

In stacking the first to fourth sub-connectors 11, 12, 13 and 14, the second sub-connector 12 is overlapped on the upper surface of the first sub-connector 11. In the process of stacking the second sub-connector 12 on the first sub-connector 11, the hold releasing portions 34 of the second sub-connector 12 interfere with the holding projections 68 of the first sub-connector 11 and resiliently deform the resilient holding pieces 67 outward in the width direction as shown in FIG. 13. By this resilient deformation, the locking of the resilient holding pieces 67 (holding projections 68) and the receiving portions 28 is released and the hold of the resilient holding pieces 67 in the first sub-connector 11 is released. Similarly, in the stacking process, the separation restricting portions 62 of the cover 50 of the second sub-connector 12 are locked to the abutting portions 61 of the cover 50 of the first sub-connector 11 from front as shown in FIG. 10, wherefore the cover 50 of the first sub-connector 11 is restricted from moving forward from the first housing 21. Therefore, a state where the cover 50 of the first sub-connector 11 is assembled with the first housing 21, i.e. a state where the tabs 42 of the first sub-connector 11 are protected by the cover 50, is held.

The vertically overlapped first and second sub-connectors 11, 12 are held in the stacked state by locking the resilient lock pieces 33 of the first housing 21 and the lock projections 32 of the second housing 22 as shown in FIG. 2. With the first and second sub-connectors 11, 12 stacked, the both housings 21, 22 are positioned in the lateral direction by fitting the hold releasing portions 34 of the second housing 22 into the upper surface recesses 30 of the first housing 21. Simultaneously, the hold releasing portions 34 of the second housing 22 are locked to the receiving portions 28 of the first housing 21 from behind, whereby the second housing 22 is restricted from relatively moving forward with respect to the first housing 21.

Thereafter, the third sub-connector 13 is overlapped on the upper surface of the second sub-connector 12. At this time, as when the second sub-connector 12 is overlapped on the upper surface of the first sub-connector 11, the hold of the resilient holding pieces 67 in the second sub-connector 12 is released by the hold releasing portions 34 of the third sub-connector 13 and the cover 50 of the second sub-connector 12 is restricted from moving forward from the second housing 22 by locking the separation restricting portions 62 and the abutting portions 61. The overlapped second and third sub-connectors 12, 13 are held in the stacked state and positioned in the lateral direction.

Further, the third housing 23 is restricted from relatively moving forward with respect to the second housing 22 by locking the hold releasing portions 34 and the receiving portions 28. As shown in FIG. 11, the projections 35 of the second housing 22 are positioned to be proximate to and face the front end edges 36F of the cut portions 36 of the third housing 23 from behind, wherefore the third housing 23 is restricted from being relatively displaced rearward with respect to the second housing 22. Further, the projections 35 of the second housing 22 enter the terminal accommodation chambers 25 through the cut portions 36 of the third housing 23 and can be locked to the secondary locking portions 45 of the male terminal fittings 40 in the third housing 23 from behind. In this way, the male terminal fittings 40 in the third housing 23 are held in a reliably retained state by the locking lances 26 and the projections 35.

Thereafter, another third housing 13 is overlapped on the upper surface of the third sub-connector 13. At this time, as when the third sub-connector 13 is overlapped on the upper surface of the second sub-connector 12, the hold of the resilient holding pieces 67 in the lower third sub-connector 13 is released by the hold releasing portions 34 of the upper third sub-connector 13 and the cover 50 of the lower third sub-connector 13 is restricted from moving forward from the third housing 23 by locking the separation restricting portions 62 and the abutting portions 61. The overlapped third sub-connectors 13 are held in the stacked state and positioned in the lateral direction.

After the three third sub-connectors 13 are stacked, the fourth sub-connector 14 is overlapped on the upper surface of the uppermost third sub-connector 13. At this time, as when the third sub-connectors 13 are overlapped, the hold of the resilient holding pieces 67 in the uppermost third sub-connector 13 is released by the hold releasing portions 34 of the fourth sub-connector 14 and the cover 50 of the uppermost third sub-connector 13 is restricted from moving forward from the third housing 23 by locking the separation restricting portions 62 and the abutting portions 61. The overlapped third and fourth sub-connectors 13, 14 are held in the stacked state and positioned in the lateral direction. The resilient holding pieces 67 of the cover 50 of the fourth sub-connector 14 are kept locked to the receiving portions 28 of the fourth housing 24. In the above way, the stacking process of the sub-connectors 11, 12, 13 and 14 is completed and the assembly of the stack connector A is completed.

### Procedure of Removing Covers 50 from Housings 21, 22, 23 and 24

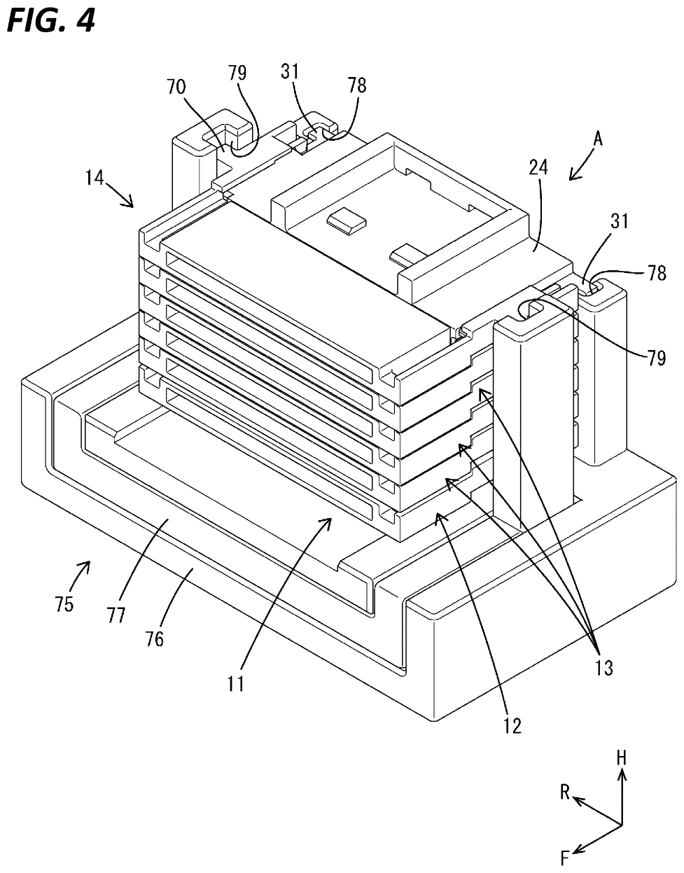

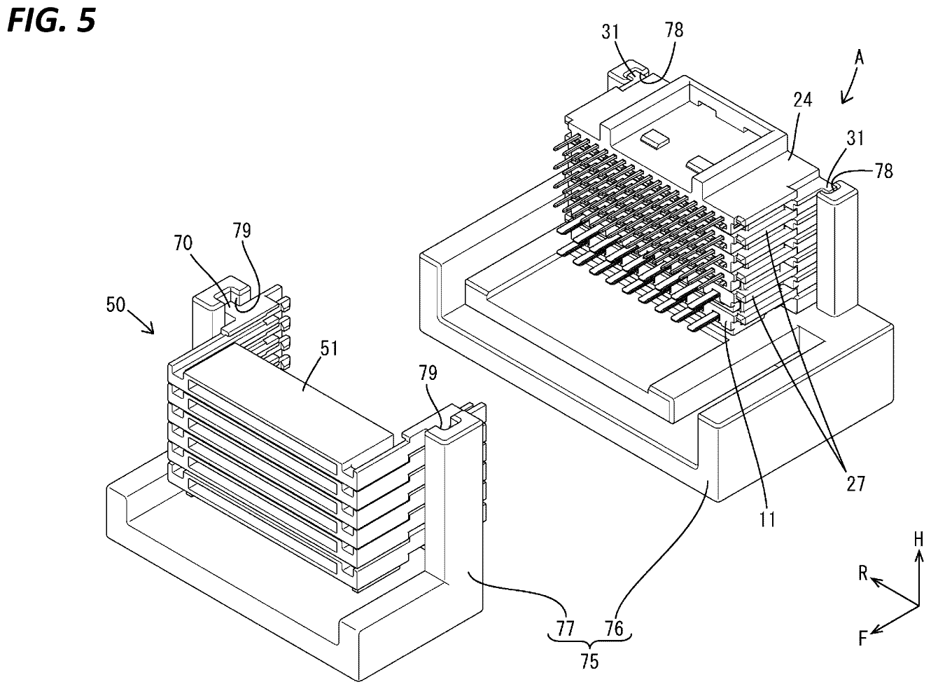

In mounting the assembled stack connector A into the outer housing (not shown), the covers 50 are removed from the housings 21, 22, 23 and 24, using a jig 75. As shown in FIGS. 4 and 5, the jig 75 is provided with a fixed member 76 and a movable member 77. The fixed member 76 is formed with fixing grooves 78 extending in the vertical direction, and the movable member 77 is formed with locking grooves 79 extending in the vertical direction. The stack connector A is set in the jig 75 with the jig fixing portions 31 of the first to fourth housings 21, 22, 23 and 24 fit in the fixing grooves 78 and the jig locking portions 70 of the covers 50 attached to the first to fourth housings 21, 22, 23 and 24 fit in the locking grooves 70 (see FIG. 4).

After the stack connector A is set in the jig 75, the resilient holding pieces 67 of the cover 50 of the fourth sub-connector 14 are disengaged from the receiving portions 28 by an operating tool or the like to release the hold of the resilient holding pieces 67 in the fourth sub-connector 14. By releasing the hold in this fourth sub-connector 14, the cover 50 of the fourth sub-connector 14 can be separated forward from the fourth housing 24 and, consequently, the covers 50 can be separated forward from the first to third housings 21, 22, 23 in the first to third sub-connectors 11, 12 and 13. With the hold of the resilient holding pieces 67 in the fourth sub-connector 14 kept released, the movable member 77 is slid forward with respect to the fixed member 76 as shown in FIG. 5. In this way, all the covers 50 can be separated forward from the first to fourth housings 21, 22, 23 and 24 by one action.

In the process of separating the covers 50 from the housings 21, 22, 23 and 24, the covers 50 are held in a fixed posture with respect to the housings 21, 22, 23 and 24 by fitting the guide ribs 27 and the guide grooves 63. Since the guide ribs 27 and the guide grooves 63 are shaped to extend in the front-rear direction parallel to a projecting direction of the tabs 42 from the housings 21, 22, 23 and 24, the covering portions 51 do not interfere with the tabs 42 in the process of separating the covers 50 from the housings 21, 22, 23 and 24.

Further, if the covers 50 are shifted in the vertical direction or inclined in the vertical direction with respect to the housings 21, 22, 23 and 24 immediately before or after the covers 50 are separated from the housings 21, 22, 23 and 24, the covering portions 51 may interfere with the tabs 42. However, since the length from the rear ends of the covering portions 51 to the rear ends of the guide grooves 63 is set to be larger than the projecting dimension of the tabs 42 from the housings 21, 22, 23 and 24, there is no possibility that the covering portions 51 interfere with the tabs 42.

The stack connector A of this embodiment is provided with the plurality of housings 21, 22, 23 and 24, the plurality of male terminal fittings 40 and the plurality of covers 50. The plurality of housings 21, 22, 23 and 24 are assembled in the state stacked in the height direction. The male terminal fittings 40 include the elongated tabs 42 in the front end parts and are mounted into the housings 21, 22, 23 and 24 with the tabs 42 projecting forward from the housings 21, 22, 23 and 24. The cover 50 includes the covering portion 51 for covering the tabs 42 and is attached to the housing 21, 22, 23, 24. With the cover 50 attached to the housing 21, 22, 23, 24, the tabs 42 can be protected by the covering portion 51.

The housings 21, 22, 23 and 24 and the covers 50 are formed with the receiving portions 28 and the resilient holding pieces 67 as holding portions for holding the housings 21, 22, 23 and 24 and the covers 50 in the attached state. Out of the two housings 21, 22, 23, 24 overlapped in the stacked state, the upper (one) housing 22, 23, 24 is formed with the hold releasing portions 34 for releasing the holding function of the receiving portions 28 in the lower housing 21, 22, 23 and the resilient holding pieces 67 as being stacked on the lower (other) housing 21, 22, 23. According to this configuration, since the holding function of the receiving portions 28 and the resilient holding pieces 67 is released only by stacking the housings 21, 22, 23 and 24, a separate step (separate operation) for releasing the holding function of the receiving portions 28 and the resilient holding pieces 67 is unnecessary.

The upper (one) cover 50 attached to the upper (one) housing 22, 23, 24, out of the two housings 21, 22, 23, 24 overlapped in the stacked state, is formed with the separation restricting portions 62. The separation restricting portions 62 restrict the forward separation of the lower (other) cover 50 from the lower housing 21, 22, 23. If the lower cover 50 is removed from the lower housing 21, 22, 23 immediately when the hold by the receiving portions 28 and the resilient holding pieces 67 is released, the tabs 42 of the lower sub-connector 11, 12, 13 are kept exposed in the process of stacking the sub-connectors 12, 13, 14 (housings 22, 23, 24) thereafter. In view of this point, the lower cover 50 released from the hold by the receiving portions 28 and the resilient holding pieces 67 is kept in a state not separated from the lower housing 21, 22, 23 by the separation restricting portions 62. In this way, the tabs 42 can be prevented from being exposed in the process of stacking the housings 21, 22, 23 and 24. If the hold of the uppermost (one) fourth housing 24 stacked last and the uppermost (one) cover 50 is released after all the housings 21, 22, 23 and 24 are stacked, all the covers 50 can be removed from the housings 21, 22, 23 and 24.

The receiving portions 28 formed in the upper (one) housing 22, 23, 24 and the resilient holding pieces 67 formed in the upper (one) cover 50 are arranged to be exposed on the outer surfaces (upper surfaces) of the upper housing 22, 23, 24 and the upper cover 50. According to this configuration, the hold of the uppermost fourth housing 24 overlapped last and the uppermost cover 50 can be easily released with all the housings 21, 22, 23 and 24 stacked.

The front surface of the covering portion 51 of the cover 50 is formed with the inspection opening 55, through which a probe P (see FIG. 11) for continuity inspection is inserted to contact the tab 42. According to this configuration, the probe P can be inserted into the covering portion 51 from the front of the cover 50 and brought into contact with the front end of the tab 42 while the tabs 42 are surrounded by the cover 50. That is, continuity inspection can be carried out while the tabs 42 are protected by the cover 50.

The housings 21, 22, 23 and 24 and the covers 50 are formed with the guide ribs 27 and the guide grooves 63 as guide portions for guiding the covers 50 to relatively displace the covers 50 with respect to the housings 21, 22, 23 and 24 in paths configured not to interfere with the tabs 42. According to this configuration, since the covers 50 are guided to move in the paths configured not to interfere with the tabs 42, the interference of the covers 50 with the tabs 42 can be prevented.

The guiding path by the guide ribs 27 and the guide grooves 63 is a straight path in the front-rear direction parallel to the projecting direction of the tabs 42. According to this configuration, even if the cover 50 is not enlarged in the vertical direction or the lateral direction, the interference of the cover 50 and the tabs 42 can be prevented. Therefore, the shapes of the housings 21, 22, 23 and 24 and those of the covers 50 can be simplified.

The housings 21, 22, 23 and 24 and the covers 50 have the flat shape having the width larger than the height. The cover 50 includes the covering portion 50 for collectively covering the plurality of tabs 42 arranged in the width direction and the arm portions 60 cantilevered rearward from both end parts in the width direction of the covering portion 51. The guide groove 63 is formed in the arm portion 60. According to this configuration, in the process of removing the cover 50 from the housing 21, 22, 23, 24, the interference of the covering portion 51 with the tabs 42 can be prevented even if the cover 50 is inclined in the height direction (vertical direction) or moves in the height direction (vertical direction) immediately after the rear end parts of the guide grooves 63 of the cover 50 are separated from the front end parts of the guide ribs 27 of the housing 21, 22, 23, 24.

The plurality of sub-connectors 11, 12, 13 and 14 (housings 21, 22, 23 and 24) are stacked in the height direction. With the plurality of housings 21, 22, 23 and 24 stacked, the plurality of covers 50 are arranged to be stacked in the height direction. The two covers 50 overlapped in the stacked state are formed with the positioning recesses 56 and the positioning protrusions 57 as positioning portions for restricting relative displacements in the width direction by being fit to each other. According to this configuration, the two covers 50 overlapped in the stacked state are restricted from being relatively displaced in the width direction by fitting the positioning protrusions 57 and the positioning recesses 56. In this way, some of the plurality of stacked covers 50 can be prevented from being shifted in the width direction with respect to the housings 21, 22, 23 and 24.

The cover 50 is formed with the jig locking portions 70 arranged in a stacking direction with the sub-connectors 11, 12, 13 and 14 stacked. According to this configuration, with all the housings 21, 22, 23 and 24 and all the covers 50 stacked, all the covers 50 can be removed from the housings 21, 22, 23 and 24 by one action by locking all the jig locking portions 70 into the locking grooves 79 of the jig 75.

The jig locking portion 70 is in the form of a projection formed by thickening at least a part of a region formed with the guide groove 63, out of the arm portion 60. According to this configuration, the rigidity of the parts formed with the guide grooves 63, out of the cover 50, is enhanced by the projection-like jig locking portions 70. Therefore, it is possible to prevent prying between the guide ribs 27 and the guide grooves 63 due to the deformation of the parts (guide portions on the side of the cover 50) formed with the guide grooves 63, out of the cover 50.

### Other Embodiments

The present invention is not limited to the above described and illustrated embodiment, but is represented by claims. The present invention includes all changes in the scope of claims and in the meaning and scope of equivalents and also includes the following embodiments.

The covering portion of the cover may be shaped to individually surround each tab.

The shape of the cover is not limited to a rectangular tube shape surrounding the entire upper, lower, left and right surfaces of the tabs and the cover may be shaped to be open in any one of the upper, lower, left and right surfaces.

The holding function of the holding portions may be released by a separate step (separate operation) without depending on the hold releasing portions.

The cover may be shaped not to include the separation restricting portions.

The cover may be shaped not to include the jig locking portions.

The holding portions may be formed not to be exposed on the outer surfaces of the housing and the cover.

The inspection opening may be individually open for each tab.

### LIST OF REFERENCE NUMERALS

A . . . stack connector
P . . . probe
11 . . . first sub-connector
12 . . . second sub-connector
13 . . . third sub-connector
14 . . . fourth sub-connector
21 . . . first housing
22 . . . second housing
23 . . . third housing
24 . . . fourth housing
25 . . . terminal accommodation chamber
26 . . . locking lance
27 . . . guide rib
28 . . . receiving portion (holding portion)
29 . . . bulging portion
30 . . . upper surface recess
31 . . . jig fixing portion
32 . . . lock projection
33 . . . resilient lock piece
34 . . . hold releasing portion
35 . . . projection
36 . . . cut portion
36F . . . front end edge of cut portion
40 . . . male terminal fitting
41 . . . terminal body portion
42 . . . tab
43 . . . crimping portion
44 . . . primary locking portion
45 . . . secondary locking portion
46 . . . wire
50 . . . cover
51 . . . covering portion
52 . . . upper wall portion
53 . . . lower wall portion
54 . . . side wall portion
55 . . . inspection opening
56 . . . positioning recess
57 . . . positioning protrusion
60 . . . arm portion
61 . . . abutting portion
62 . . . separation restricting portion
63 . . . guide groove
64 . . . side plate portion
65 . . . upper plate portion
66 . . . lower plate portion
67 . . . resilient holding piece (holding portion)
68 . . . holding projection
69 . . . protecting portion
70 . . . jig locking portion
75 . . . jig
76 . . . fixed member
77 . . . movable member
78 . . . fixing groove
79 . . . locking groove

1. A stack connector, comprising:
a plurality of housings to be assembled in a stacked state;
male terminal fittings each including an elongated tab in a front end part, the male terminal fittings being mounted into the housings with the tabs projecting forward from the housings; and
covers to be attached to the housings, the covers including covering portions for covering the tabs.

2. The stack connector of claim 1, wherein:
the housings and the covers are formed with holding portions for holding the housings and the covers in an attached state, and
one of two housings overlapped in a stacked state is formed with a hold releasing portion for releasing a holding function of the holding portion in the other housing as the one housing is stacked on the other housing.

3. The stack connector of claim 2, wherein, out of the two covers overlapped in the stacked state, one cover attached to the one housing is formed with a separation restricting portion for restricting separation of the other cover from the other housing.

4. The stack connector of claim 3, wherein the holding portions formed in the one housing and the one cover are arranged to be exposed on outer surfaces of the one housing and the one cover.

5. The stack connector of claim 3, wherein the covers are formed with jig locking portions arranged in a stacking direction with the housings stacked.

6. The stack connector of claim 1, wherein an inspection opening is formed in a front surface of the cover, a probe for continuity inspection being inserted through the inspection opening to contact the tab.
